(19) United States
(12) Patent Application Publication
(10) Pub. No.: US 2026/0145526 A1
(43) Pub. Date: May 28, 2026

(54) DYNAMIC VISIBILITY ENHANCEMENT AND ASSISTANCE

(71) Applicant: GM Global Technology Operations LLC, Detroit, MI (US)

(72) Inventors: Michael John Aprile, Shelby Township, MI (US); Tetyana Wasko, West Bloomfield, MI (US); Russell A. Patenaude, Macomb Township, MI (US); Hannah Elizabeth Wagner, Berkley, MI (US)

(21) Appl. No.: 18/959,936

(22) Filed: Nov. 26, 2024

(51) Int. Cl. B60K 35/81; B60K 35/65; G06T 7/70; G06V 20/20; G06V 20/56; G06V 20/59

(52) U.S. Cl. CPC B60K 35/285; B60K 35/654; G06T 7/70; G06V 20/20; G06V 20/56; G06V 20/597; B60K 2360/177; B60K 2360/21; B60K 2360/349; G06T 2207/30201; G06T 2207/30252; G06T 2207/30268

(57) ABSTRACT

A system and method for operating a vehicle. A gaze sensor obtains an image of a face of a driver of the vehicle. An environmental sensor obtains environmental data related to an environmental condition and a remote object, a human machine interface, and a processor. The processor is configured to obtain a user profile for the driver of the vehicle, wherein the user profile indicates a visible region and a blind spot in a field-of-view of the driver, determine a gaze condition of the driver from the image, determine a location of the remote object from the environmental data, analyze the gaze condition and the environmental data to determine the remote object to be in the blind spot of the driver, and perform a remedial action at the human machine interface to enhance a visibility of the remote object in the blind spot.

The subject disclosure relates to vehicles and, in particular, to a system and method for enhancing a visibility of a driver, especially based on knowledge of blind spots of the driver.

A driver of a vehicle may have to cope with various visual impairments that affect his ability to operate the vehicle. These visual impairments can include scotoma or blind spots in the driver's field of vision, as well as blurred vision, glaucoma, etc. Because our brains typically “fill in” these blind spots, the driver may not notice these blind spots or be able to gain information about objects that are in the blind spots and that affect the driving of a vehicle. Accordingly, it is desirable to bring to the attention of the driver an object that is within the driver's blind spot.

### SUMMARY

In one exemplary embodiment, a method of operating a vehicle is disclosed. A user profile for a driver of the vehicle is obtained, wherein the user profile indicates a visible region and a blind spot in a field-of-view of the driver. An image of a face of the driver is obtained to determine a gaze condition of the driver. An environment of the vehicle is monitored to obtain environmental data and to determine a location of a remote object. The gaze condition and the environmental data are analyzed to determine the remote object to be in the blind spot of the driver. A remedial action is performed at the vehicle to enhance a visibility of the remote object in the blind spot.

In addition to one or more of the features described herein, the method further includes analyzing the gaze condition and the environmental data using a model having a model parameter and a weight associated with the model parameter, further comprising evaluating a response of the driver to the remedial action to determine a confidence value and adjusting the weight based on the confidence value.

In addition to one or more of the features described herein, the method further includes taking an escalation action when performing the remedial action does not result in improved performance of the driver.

In addition to one or more of the features described herein, performing the remedial action further includes determining a section of a display in the visible region of the field-of-view and one of displaying a visual signal representative of the remote object at the display within the visible region of the driver and moving the visual signal from the blind spot to the visible region.

In addition to one or more of the features described herein, performing the remedial action further comprises adjusting a design parameter of a visual signal at a display, the design parameter including at least one of a font size of a letter, a brightness of the visual signal, and causing the visual signal to flash.

In addition to one or more of the features described herein, performing the remedial action further comprises augmenting a reality for the driver, wherein augmenting the reality includes at least one of displaying augmented lane markers and displaying a distance from the vehicle to the remote object.

In addition to one or more of the features described herein, the blind spot is at least one of due to a structure of the vehicle, inherent to the driver, due to an environmental condition, and due to traffic conditions.

In another exemplary embodiment, a system for operating a vehicle is disclosed. The system includes a processor configured to obtain a user profile for a driver of the vehicle, wherein the user profile includes a visible region and a blind spot in a field-of-view of the driver, obtain an image of a face of the driver to determine a gaze condition of the driver, monitor an environment of the vehicle to obtain environmental data and to determine a location of a remote object, analyze the gaze condition and the environmental data to determine the remote object to be in the blind spot of the driver, and perform a remedial action at the vehicle to enhance a visibility of the remote object in the blind spot.

In addition to one or more of the features described herein, the processor is further configured to analyze the gaze condition and the environmental data using a model having a model parameter and a weight associated with the model parameter, evaluate a response of the driver to the remedial action to determine a confidence value and adjust the weight based on the confidence value.

In addition to one or more of the features described herein, the processor is further configured to take an escalation action when performing the remedial action does not result in improved performance of the driver.

In addition to one or more of the features described herein, the processor is further configured to perform the remedial action by determining a section of a display in the visible region of the field-of-view and one of displaying a visual signal representative of the remote object at the display within the visible region of the driver and moving the visual signal from the blind spot to the visible region.

In addition to one or more of the features described herein, the processor is further configured to perform the remedial action by adjusting a design parameter of a visual signal at a display, the design parameter including at least one of a font size of a letter, a brightness of the visual signal, and causing the visual signal to flash.

In addition to one or more of the features described herein, the processor is further configured to perform the remedial action by augmenting a reality for the driver, wherein augmenting the reality includes at least one of displaying augmented lane markers and displaying a distance from the vehicle to the remote object.

In addition to one or more of the features described herein, the blind spot is at least one of due to a structure of the vehicle, inherent to the driver, due to an environmental condition, and due to traffic conditions.

In yet another exemplary embodiment, a vehicle is disclosed. The vehicle includes a gaze sensor for obtaining an image of a face of a driver of the vehicle, an environmental sensor for obtaining environmental data related to an environmental condition and a remote object, a human machine interface, and a processor. The processor is configured to obtain a user profile for the driver of the vehicle, wherein the user profile indicates a visible region and a blind spot in a field-of-view of the driver, determine a gaze condition of the driver from the image, determine a location of the remote object from the environmental data, analyze the gaze condition and the environmental data to determine the remote object to be in the blind spot of the driver, and perform a remedial action at the human machine interface to enhance a visibility of the remote object in the blind spot.

In addition to one or more of the features described herein, the processor is further configured to analyze the gaze condition and the environmental data using a model having a model parameter and a weight associated with the model parameter, evaluate a response of the driver to the remedial action to determine a confidence value and adjust the weight based on the confidence value.

In addition to one or more of the features described herein, the processor is further configured to take an escalation action when performing the remedial action does not result in improved performance of the driver.

In addition to one or more of the features described herein the processor is further configured to perform the remedial action by determining a section of a display in the visible region of the field-of-view and one of displaying a visual signal representative of the remote object at the display within the visible region of the driver and moving the visual signal from the blind spot to the visible region.

In addition to one or more of the features described herein, the processor is further configured to perform the remedial action by adjusting a design parameter of a visual signal at a display, the design parameter including at least one of a font size of a letter, a brightness of the visual signal, and causing the visual signal to flash.

In addition to one or more of the features described herein, the processor is further configured to perform the remedial action by augmenting a reality for the driver, wherein augmenting the reality includes at least one of displaying augmented lane markers and displaying a distance from the vehicle to the remote object.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with an associated trajectory planning system depicted in accordance with various embodiments;

FIG. 2 is an illustrative field-of-view of a driver of the autonomous vehicle;

FIG. 3 is a schematic diagram of a visibility enhancement system of the vehicle, in an embodiment; and

FIG. 4 is a flowchart of a method of dynamically enhancing a visibility to the driver.

### DETAILED DESCRIPTION

The following description is merely exemplary in nature and is not intended to limit the present disclosure, its application or uses. It should be understood that throughout the drawings, corresponding reference numerals indicate like or corresponding parts and features.

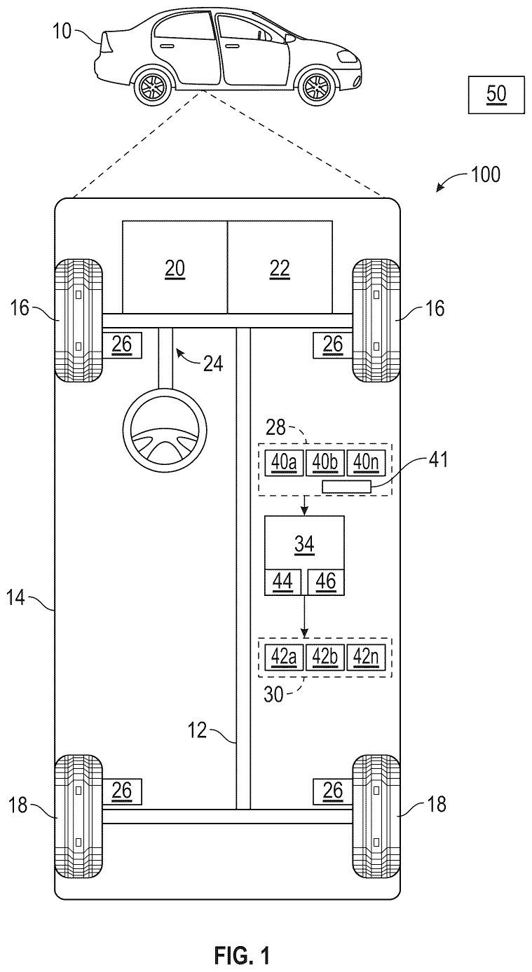

In accordance with an exemplary embodiment, FIG. 1 shows an autonomous vehicle 10 with an associated trajectory planning system depicted at 100. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle has different levels of intervention or control of the vehicle through coupled assistive vehicle control all the way to full control of all vehicle functions. The autonomous vehicle 10 can be any of a Level One through Level Five system. A Level 1 system includes driver assistance and performs a single autonomous task at a time, such as steering or braking. The Level 1 system can include cruise control and lane detection. A Level 2 system includes partial driving automation. Such a vehicle can control both steering and speed, but the driver must be ready to take over in an emergency. A Level 3 system is a conditional driving automation system that includes environmental detection capabilities. Such a vehicle can perform most driving tasks, but a human override is still required. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The sensor system 28 further includes internal sensing devices 41 that monitor the driver or user. The internal sensing devices 41 can include a camera or digital camera directed at a head of the driver to capture an image or video of a face of the driver.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. The instruction may also perform logic, calculations, methods and/or algorithms for enhancing a visibility of the driver using the methods disclosed herein.

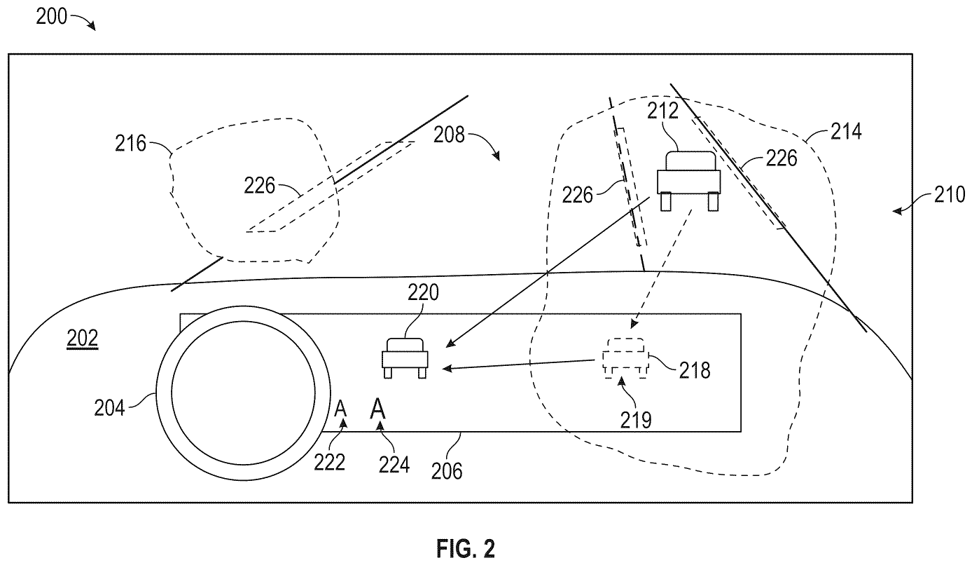

FIG. 2 is an illustrative field-of-view 200 of a driver of the autonomous vehicle 10. The illustrative field-of-view 200 shows a dashboard 202 and a steering wheel 204. A display 206 is located at the dashboard 202. The display 206 can be a human machine interface that displays visual signals and allows data entry from the driver. A road 208 being traversed by the autonomous vehicle 10 is visible through a front window 210. The front window 210 can include a head up display. Various objects, such as vehicles, pedestrians, animals, etc., can be along the road. Remote vehicle 212 represents an object on the road 208.

The field-of view includes visible regions and blind spots. A first blind spot 214 and a second blind spot 216 are shown for illustrative purposes. The blind spots can be vehicular blind spots due to the shape or structure of the autonomous vehicle 10. The blind spots can also be inherent to the driver due to a medical or ophthalmological condition. The blind spots can also be due to environmental conditions, such as the location of the Sun in the driver's field of view, glare, night blindness, rain conditions, snow conditions, etc. The blind spots can also be due to traffic conditions, such as headlights of oncoming vehicles. A blind spot can refer to a location or region within a field-of-view in which the driver does not have the ability to see an object. A blind spot can also be a location or region in which visibility is partially impaired, blurred, etc. The blind spot can be unique to the driver and is a dynamic region which changes based on various conditions of the driver and environment.

A non-limiting set of visibility enhancement methods are illustrated in FIG. 2. The methods include moving a visual signal or a visual representation at the display 206 from a blind spot of the driver to a visible region of the driver. The methods further include changing a design parameter of a visual signal such as an icon or a letter. Changing the design parameter can include changing a font, changing a brightness, changing a size, causing the letter or icon to flash, etc. In another example, augmented lane markers can be added at the front window 210 (e.g., via a head up display). Other visibility enhancement methods can also be implemented, as discussed herein.

With respect to moving visual signals from a blind spot to a visible region, the remote vehicle 212 is shown as being located within the first blind spot. An icon 218 is shown at a first location 219 of the display 206 to represent the remote vehicle 212 to the driver. However, the first location 219 is still in the first blind spot 214. The methods disclosed herein can observe the first blind spot 214, determine that an icon or other object at the display is within the first blind spot 214 and move the location of the icon to a second location 220 within a visible region of the driver in order to enhance a visibility of the visual signal to the driver. With respect to changing the design parameter, a first letter 222 is shown in a font that may be too small, too dim, etc., to allow for easy visibility or comprehension. The methods can be used the change font size, make the letter brighter or bolder or other visibility enhancement device, as illustrated by second letter 224. With respect to increase visibility of lane markers, the methods can include adding augmented lane markers 226 at the head up display when the blind spot or glare prevents the driver from clearly seeing the lane markers ahead.

In addition to visual signals, the human machine interface of the display can be used to provide a haptic signal or and/or an audio signal to alert the driver, as necessary.

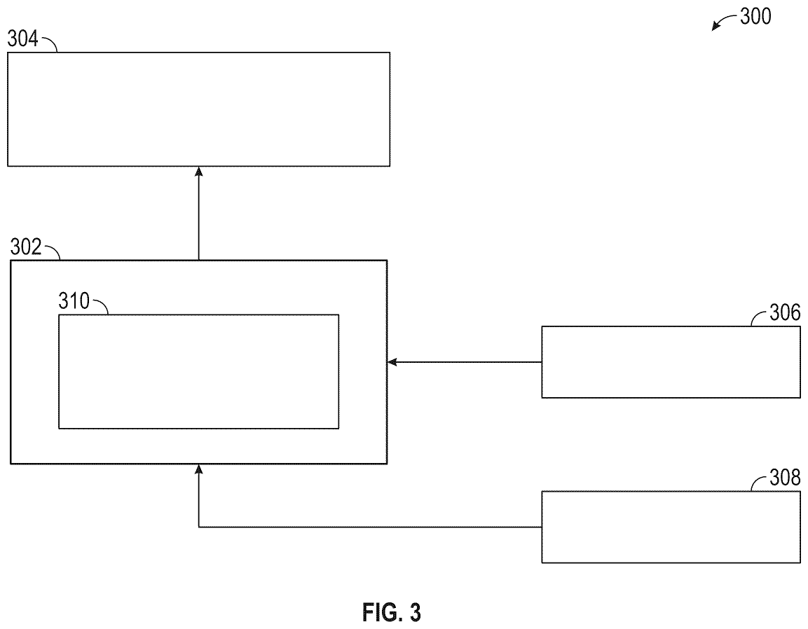

FIG. 3 is a schematic diagram of a visibility enhancement system 300 of the vehicle, in an embodiment. The visibility enhancement system 300 includes a visibility controller 302 (such as controller 34), a visibility enhancement device 304, gaze sensors 306 and environmental sensors 308. The visibility enhancement device 304 includes various displays and/or a human machine interface, such as a dashboard display, a head up display, a haptic transducer, an audio device (such as a loudspeaker), etc.

The gaze sensors 306 can include a camera facing the driver. The gaze sensors 306 capture information or data about a gaze condition of the driver. The gaze condition represents an awareness of the driver to his surrounding environment. The gaze condition can be determined by observing various behaviors of the driver, such as the dynamic head direction of the driver, repeated head movements of the driver, squinting by the driver or hyperfocus of the driver. In addition, the gaze condition can be determined by observing a state of the vehicle, such as the turn signal remaining on for a time period that exceeds a time threshold.

The environmental sensors 308 include various sensors for obtaining information or environmental data about the environment or surroundings, including remote objects, remote vehicles, pedestrians, bicyclists, etc., as well as weather conditions, glare conditions, etc. The environmental sensors 308 can include cameras, radar, Lidar, etc. The environmental sensors 308 can track objects in predefined locations, objects in user-specified locations, unexpected or abnormal objects, a direction and/or brightness of the Sun and/or headlights, daytime, nighttime, rain conditions, snow conditions, clear conditions, etc.

The visibility controller 302 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The visibility controller 302 may include a non-transitory computer-readable medium that stores instructions which, when processed by one or more processors of the visibility controller 302, implement a method of enhancing a visibility of the driver and/or a driving capability of the driver, according to one or more embodiments detailed herein.

The visibility controller 302 receives data from the gaze sensors 306 and the environmental sensors 308 and determines a visibility of the driver from this data. The visibility controller 302 performs a dynamic visibility model 310 that analyzes various data (including environmental data and gaze data) to determine an ability of the driver to perceive the objects relevant to driving the vehicle, including based on a blind spot of the driver. The dynamic visibility model 310 includes various model parameters. The importance of a model parameter to the model can be increased or decreased by changing a value of a weight and/or coefficient associated with the model parameter.

The dynamic visibility model 310 can track a blind spot of the driver and can propose a remedial action to enhance a visibility of the driver based on the location of the blind spot. The weights of the model parameters of the dynamic visibility model 310 can be changed based on various results. In one example, the visibility controller 302 can determine, from monitoring environmental data and gaze data, that the location or shape of the blind spot has changed and can change a weight of a model parameter of the dynamic visibility model 310 to reflect the change.

The visibility controller 302 can also evaluate the ability of the dynamic visibility model 310 to improve the driver's ability to control the vehicle to establish a confidence value of the dynamic visibility model 310. An effectiveness of the dynamic visibility model 310 can be determined from the confidence value. If the confidence value is within a desired range, the visibility controller 302 can continue to operate the dynamic visibility model 310 with its current weights and/or coefficients. If the confidence value is outside of a desired range, the visibility controller 302 can adjust or update one or more weights and/or coefficients of the dynamic visibility model 310 and operate the updated model.

Thus, the visibility controller 302 can determine the location, shape and character of the blind spot from monitoring repeated regions in which the driver fails to notice relevant objects and can update this information in a user profile of the driver.

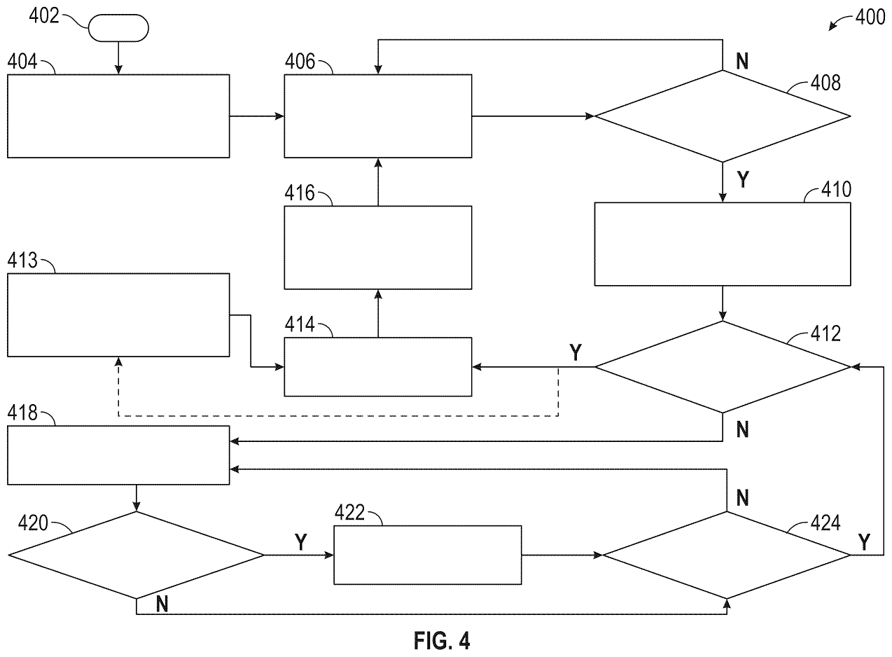

FIG. 4 is a flowchart 400 of a method of dynamically enhancing a visibility to the driver. In particular, the method is useful in locating blind spots of a driver and making suitable adjustments to allow the driver to see any objects whose visibility is affected by the blind spots.

The method starts in box 402. In box 404, a user profile is loaded into the visibility controller 302 of the visibility enhancement system 300. Alternatively, a user profile can be set up at the visibility controller 302. A user profile provides information about various blind spots of the driver. In box 406, the controller receives environmental data regarding the surroundings of the vehicle (from the environmental sensors 308) as well as gaze data regarding the gaze condition of the driver (from the gaze sensors 306) in order to determine a visibility condition for the driver. In box 408, the state of the visibility conditions is evaluated. The visibility conditions can be evaluated by comparing one or more parameters of the gaze condition to a selected threshold or thresholds. If the visibility conditions are considered acceptable, the method returns to box 406 for continued monitoring. Otherwise, the method proceeds to box 410.

In box 410, the visibility controller 302 (e.g., operating the visibility enhancement model) performs a remedial action to improve the visual perception of the driver and/or the driving capabilities of the driver. The model is dependent upon the type of awareness issue (which is determined by the visibility controller 302 from environmental data and gaze data). In one example, the location of information at the display 206 can be moved from a location in a blind spot of the driver to a location within a visible field of the driver or within a current location at which the driver is gazing. In another example, an icon representing an object such as a remote vehicle, pedestrian, bicyclist, or other road user, at the display can be moved to a different location of the display. In another example, font size, brightness, color and other design parameters of an alert can be changed to grab the attention of the driver. In another example, augmented reality can be activated. Augmented reality can include, but is not limited to, a distance to other road users, lane markers, etc.

In box 412, the driver is monitored to determine whether the changes affect a performance of the driver. If the changes have a positive effect on the driver's control of the vehicle, the method proceeds to box 414. In box 414, a confidence value of the dynamic visibility model is adjusted based on the improved control of the vehicle by the driver. Alternatively, the method can proceed from box 412 to box 413. In box 413, the user can be requested to update blind spot information. The method then proceeds to box 414. From box 414, the method proceeds to box 416. In box 416, visibility data and driver event data (e.g., behavior of the driver or response of the driver to visibility enhancement data) is uploaded to a cloud computer for storage and/or to update a user profile.

Returning to box 412, if the visibility enhancement results in little or no improvement by the driver, the method proceeds to box 418. In box 418, an escalation action is taken, which can include presenting an escalation notification and/or a suggested action to the driver. In box 420, the controller determines whether a safety override action is necessary. In other words, the controller determines whether the driver is responding to the escalation action taken in box 418. If the driver is not responsive, the method proceeds to box 422. Otherwise, the method proceeds to box 424.

In box 422, the controller takes control or partial control of the vehicle by, for example, applying brakes, activating a cruise control, controlling the steering wheel, etc. From box 422, the method proceeds to box 424. In box 424, the method evaluates whether the control actions taken by the vehicle were successful. If the control actions were not successful, the method returns to box 418. Otherwise, the method returns to box 412.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
obtaining a user profile for a driver of the vehicle, wherein the user profile indicates a visible region and a blind spot in a field-of-view of the driver;
obtaining an image of a face of the driver to determine a gaze condition of the driver;
monitoring an environment of the vehicle to obtain environmental data and to determine a location of a remote object;
analyzing the gaze condition and the environmental data to determine the remote object to be in the blind spot of the driver; and
performing a remedial action at the vehicle to enhance a visibility of the remote object in the blind spot.

2. The method of claim 1, further comprising analyzing the gaze condition and the environmental data using a model having a model parameter and a weight associated with the model parameter, further comprising evaluating a response of the driver to the remedial action to determine a confidence value and adjusting the weight based on the confidence value.

3. The method of claim 1, further comprising taking an escalation action when performing the remedial action does not result in improved performance of the driver.

4. The method of claim 1, wherein performing the remedial action further comprises determining a section of a display in the visible region of the field-of-view and one of: (i) displaying a visual signal representative of the remote object at the display within the visible region of the driver; and (ii) moving the visual signal from the blind spot to the visible region.

5. The method of claim 1, wherein performing the remedial action further comprises adjusting a design parameter of a visual signal at a display, the design parameter including at least one of: (i) a font size of a letter; (ii) a brightness of the visual signal; and (iii) causing the visual signal to flash.

6. The method of claim 1, wherein performing the remedial action further comprises augmenting a reality for the driver, wherein augmenting the reality includes at least one of: (i) displaying augmented lane markers; and (ii) displaying a distance from the vehicle to the remote object.

7. The method of claim 1, wherein the blind spot is at least one of: (i) due to a structure of the vehicle; (ii) inherent to the driver; (iii) due to an environmental condition; and (iv) due to traffic conditions.

8. A system for operating a vehicle, comprising:
a processor configured to:
obtain a user profile for a driver of the vehicle, wherein the user profile includes a visible region and a blind spot in a field-of-view of the driver;
obtain an image of a face of the driver to determine a gaze condition of the driver;
monitor an environment of the vehicle to obtain environmental data and to determine a location of a remote object;
analyze the gaze condition and the environmental data to determine the remote object to be in the blind spot of the driver; and
perform a remedial action at the vehicle to enhance a visibility of the remote object in the blind spot.

9. The system of claim 8, wherein the processor is further configured to analyze the gaze condition and the environmental data using a model having a model parameter and a weight associated with the model parameter, evaluate a response of the driver to the remedial action to determine a confidence value and adjust the weight based on the confidence value.

10. The system of claim 8, wherein the processor is further configured to take an escalation action when performing the remedial action does not result in improved performance of the driver.

11. The system of claim 8, wherein the processor is further configured to perform the remedial action by determining a section of a display in the visible region of the field-of-view and one of: (i) displaying a visual signal representative of the remote object at the display within the visible region of the driver; and (ii) moving the visual signal from the blind spot to the visible region.

12. The system of claim 8, wherein the processor is further configured to perform the remedial action by adjusting a design parameter of a visual signal at a display, the design parameter including at least one of: (i) a font size of a letter; (ii) a brightness of the visual signal; and (iii) causing the visual signal to flash.

13. The system of claim 8, wherein the processor is further configured to perform the remedial action by augmenting a reality for the driver, wherein augmenting the reality includes at least one of: (i) displaying augmented lane markers; and (ii) displaying a distance from the vehicle to the remote object.

14. The system of claim 8, wherein the blind spot is at least one of: (i) due to a structure of the vehicle; (ii) inherent to the driver; (iii) due to an environmental condition; and (iv) due to traffic conditions.

15. A vehicle, comprising:
a gaze sensor for obtaining an image of a face of a driver of the vehicle;
an environmental sensor for obtaining environmental data related to an environmental condition and a remote object;
a human machine interface; and
a processor configured to:
obtain a user profile for the driver of the vehicle, wherein the user profile indicates a visible region and a blind spot in a field-of-view of the driver;
determine a gaze condition of the driver from the image;
determine a location of the remote object from the environmental data;
analyze the gaze condition and the environmental data to determine the remote object to be in the blind spot of the driver; and
perform a remedial action at the human machine interface to enhance a visibility of the remote object in the blind spot.

16. The vehicle of claim 15, wherein the processor is further configured to analyze the gaze condition and the environmental data using a model having a model parameter and a weight associated with the model parameter, evaluate a response of the driver to the remedial action to determine a confidence value and adjust the weight based on the confidence value.

17. The vehicle of claim 15, wherein the processor is further configured to take an escalation action when performing the remedial action does not result in improved performance of the driver.

18. The vehicle of claim 15, wherein the processor is further configured to perform the remedial action by determining a section of a display in the visible region of the field-of-view and one of: (i) displaying a visual signal representative of the remote object at the display within the visible region of the driver; and (ii) moving the visual signal from the blind spot to the visible region.

19. The vehicle of claim 15, wherein the processor is further configured to perform the remedial action by adjusting a design parameter of a visual signal at a display, the design parameter including at least one of: (i) a font size of a letter; (ii) a brightness of the visual signal; and (iii) causing the visual signal to flash.

20. The vehicle of claim 15, wherein the processor is further configured to perform the remedial action by augmenting a reality for the driver, wherein augmenting the reality includes at least one of: (i) displaying augmented lane markers; and (ii) displaying a distance from the vehicle to the remote object.
